(19) United States
(12) Patent Application Publication
(10) Pub. No.: US 2018/0157320 A1
(43) Pub. Date: Jun. 7, 2018

(54) AIR SPACED OPTICAL ASSEMBLY WITH INTEGRATED EYE TRACKING

(71) Applicant: Oculus VR, LLC, Menlo Park, CA (US)

(72) Inventor: Nicholas Daniel Trail, Bothell, WA (US)

(21) Appl. No.: 15/366,412

(22) Filed: Dec. 1, 2016

(51) Int. Cl. G06F 3/01; G02B 27/00; G02B 27/01; G06K 9/00

(52) U.S. Cl. CPC G06F 3/013; G06K 9/00604; G02B 27/0172; G02B 27/0093

(57) ABSTRACT

A head-mounted display (HMD) includes a display, an optical assembly and an eye tracking system that determines user's eye tracking information. The optical assembly comprises a front optical element in series with a back optical element adjacent to the display. One surface of the back optical element is coated to reflect infrared (IR) light. The eye tracking system includes an illumination source and an imaging device positioned between the front optical element and the back optical element. The illumination source emits IR light that illuminates the coated surface and reflects towards the user's eye. The imaging device captures an image of the user's eye based on light reflected from the user's eye and from the coated surface. The eye tracking information is determined based on the captured image. The HMD adjusts presentation of images displayed on the display, based on the eye tracking information.

### BACKGROUND

The present disclosure generally relates to eye tracking in virtual and augmented reality systems, and specifically relates to an air spaced optical assembly with integrated eye tracking.

For further development of virtual reality (VR) systems, augmented reality (AR) systems and mixed reality (MR) systems, eye tracking serves as a necessary technology advancement that provides information related to user's interaction and gaze direction. With efficient implementation of eye tracking, VR, AR and MR systems can focus on aspects that are directly related to a visual experience of an end-user. Based on information related to an orientation of a user's eye in an eye-box (e.g., eye-gaze angle), a maximum pixel density (in a traditional display vernacular) can be provided only in a foveal region of the user's gaze, while a lower pixel resolution can be used in other regions leading to savings in power consumption and computing cycles. The resolution of pixel density can be reduced in non-foveal regions either gradually or in a step-wise fashion (e.g., by over an order of magnitude per each step). Furthermore, based on the information about orientation of user's eye and eye-gaze, variable focus for an electronic display can be achieved, optical prescriptions can be corrected, an illumination path can be provided, etc.

Integrating eye tracking into a small form-factor package that maintains stability and calibration can be often challenging. Traditionally, eye tracking architectures are based on an image being formed through the use of a planar “hot mirror”, or by utilizing devices that work based on substantially similar methods. When the “hot mirror” approach is employed, an imaging device (camera) looks back at and bounces light off of the hot mirror in an infrared (IR) wavelength range to visualize a user's eye-box. In the imaging approach, this provides a path for the camera to image the eye-box region of the device, which will allow a pupil of a user's eye to be imaged and correlated to a gaze direction. In an alternative configuration, the hot mirror can also be used in a non-imaging configuration, avoiding the need to process and use an image of the pupil. This can be achieved based on correlating an eye-gaze coordinate with a maximized “red-eye” light signal, which is maximized around the foveal location due to the so-called “foveal reflex.”

However, implementing the hot-mirror based eye tracking, whether imaging or non-imaging, into a small package that maintains stability and calibration is challenging. Therefore, more efficient methods for eye-tracking are desired for implementation in VR, AR and MR systems.

### SUMMARY

Embodiments of the present disclosure support a HIVID that comprises an electronic display, an optical assembly, an illumination source, an imaging device, and a controller. The HIVID may be, e.g., a virtual reality (VR) system, an augmented reality (AR) system, a mixed reality (MR) system, or some combination thereof. The optical assembly comprises a front optical element in series with a back optical element adjacent to the electronic display. The back optical element comprises a first surface adjacent to the electronic display and a second surface opposite to the first surface configured to reflect light of a defined range of wavelengths. The illumination source positioned between the front optical element and the back optical element is configured to illuminate the second surface of the back optical element with light having one or more wavelengths within the defined range of wavelengths. The imaging device positioned between the front optical element and the back optical element is configured to capture an image of a user's eye illuminated with light emitted from the illumination source having the one or more wavelengths reflected from the second surface of the back optical element. The controller coupled to the imaging device is configured to determine an orientation of the user's eye based on the captured image. The HIVID is configured to adjust presentation of one or more images displayed on the electronic display, based on the determined orientation of the user's eye. By adjusting focus of image light in accordance with the determined eye orientation, the HIVID can mitigate vergence-accommodation conflict. Furthermore, the HIVID can perform foveated rendering of the one or more displayed images based on the determined eye orientation.

### BRIEF DESCRIPTION OF THE DRAWINGS

FIG. 1 is a diagram of a head-mounted display (HMD), in accordance with an embodiment.

FIG. 2 is a cross section of a front rigid body of the HIVID in FIG. 1, in accordance with an embodiment.

FIG. 3 is a flow chart illustrating a process of determining eye tracking information and adjusting presentation of displayed images based on the determined eye tracking information, which may be implemented at the HIVID shown in FIG. 1, in accordance with an embodiment.

FIG. 4 is a block diagram of a system environment that includes the HIVID shown in FIG. 1 with integrated eye tracking, in accordance with an embodiment.

The figures depict embodiments of the present disclosure for purposes of illustration only. One skilled in the art will readily recognize from the following description that alternative embodiments of the structures and methods illustrated herein may be employed without departing from the principles, or benefits touted, of the disclosure described herein.

### DETAILED DESCRIPTION

Disclosed embodiments include an eye tracking system integrated into a head-mounted display (HMD). The HMD may be part of, e.g., a virtual reality (VR) system, an augmented reality (AR) system, a mixed reality (MR) system, or some combination thereof. The HIVID may further include an electronic display and an optical assembly. An approach for integrating the eye tracking system into the HIVID is based herein on leveraging a doublet optical design of the optical assembly that includes a front optical element closest to a user of the HIVID that is placed in optical series with a back optical element closest to the electronic display, with an air gap between the front optical element and the back optical element. The back optical element includes a first surface closest to the electronic display and a second surface opposite to the first surface that is coated (e.g., with dichroic coating) to reflect infrared (IR) light and transmit visible light. In one or more embodiments, the second coated surface of the back optical element is spherical and symmetrical, which facilitate the coating process. In alternative embodiments, a shape of the second coated surface of the back optical element can be aspherical, or free-form.

In some embodiments, the eye tracking system is folded into the air gap of the optical assembly between the front optical element and the back optical element, outside of a line of sight of the user of the HIVID. The eye tracking system includes an illumination source (e.g., an infrared (IR) source) and an imaging device (e.g., IR camera). The illumination source is oriented to illuminate the coated second surface of the back optical element such that IR light emitted from the illumination source is reflected from the coated second surface towards an eye of the user. The imaging device is oriented to capture an image of the user's eye illuminated with the IR light reflected from the coated second surface of the back optical element. A controller coupled to the imaging device can determine eye tracking information associated with the user's eye based on the captured image. The HIVID can adjust resolution and/or focus of images displayed on the electronic display, based on the determined eye tracking information. In one or more embodiments, the electronic display and/or optical elements in the optical assembly can move to dynamically vary focus of the images displayed on the electronic display in order to, e.g., mitigate potential problems with vergence-accommodation conflict (VAC).

In some embodiments, surfaces of the back optical element may facilitate more variables for a display path of image light output from the electronic display towards the user's eye, and fold an eye tracking path of the IR light to the user's eye-box location, with an offset in an incidence angle less than a wide field of view conventionally found in HIVID-based systems. If the eye tracking system was not folded between the front optical element and the back optical element of the optical assembly, the implemented eye tracking system would be too large to allow practical application due to potential distortion or un-viewable regions of the user's eye-box. In addition, the coated surface of the back optical element in the optical assembly can be utilized as an infrared reflector, and allows for buried (i.e., outside of an optical path of the HIVID—and a user's line of sight) illumination sources to also bounce off of the coated surface and be folded into the eye-box. This further allows for potentially smaller incidence angles as well and provides another means to facilitate glint or diffuse eye tracking, solely or in conjunction with ‘external’ illumination sources. The illumination sources of the eye tracking system may comprise lasers or light emitting diodes (LEDs), which can also be constructed to operate as a part of a structured light engine that enables the laser or LED to generate structured light cues across the eye-box.

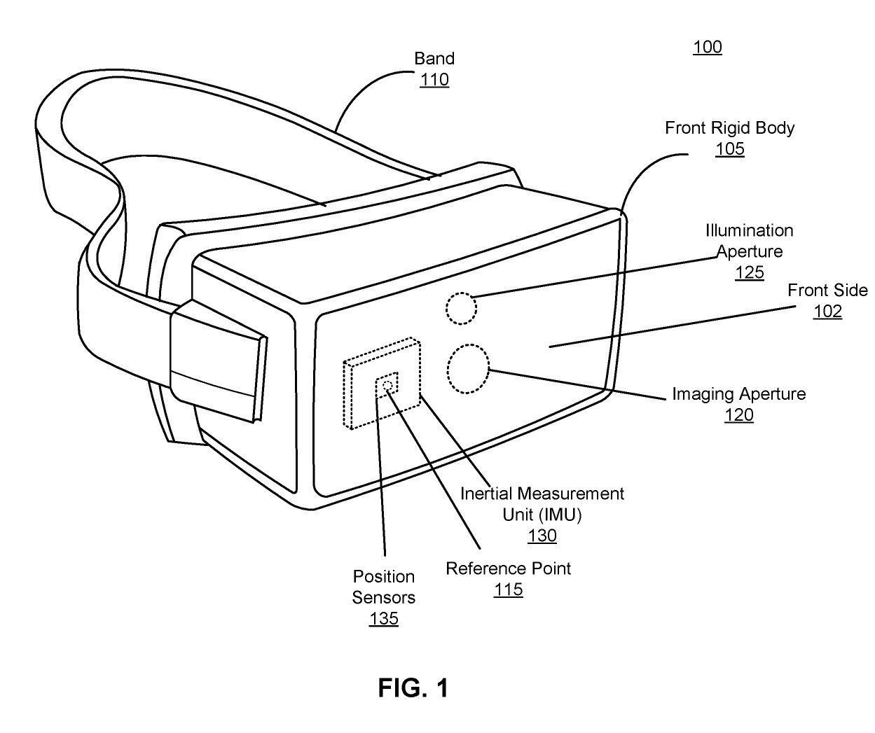

FIG. 1 is a diagram of a HMD 100, in accordance with an embodiment. The HMD 100 may be part of, e.g., a VR system, an AR system, a MR system, or some combination thereof. In embodiments that describe AR system and/or a MR system, portions of the HIVID 100 that are between a front side 102 of the HIVID 100 and an eye of the user are at least partially transparent (e.g., a partially transparent electronic display). The HIVID 100 includes a front rigid body 105, a band 110, and a reference point 115. In some embodiments, the HIVID 100 shown in FIG. 1 also includes an embodiment of a depth camera assembly (DCA) and depicts an imaging aperture 120 and an illumination aperture 125. Some embodiments of the DCA include an imaging device, and an illumination source. The illumination source emits light through the illumination aperture 125. The imaging device captures light from the illumination source and ambient light in the local area through the imaging aperture 120. In some embodiment, light emitted from an illumination source through the illumination aperture 125 comprises a structured light pattern.

In one embodiment, the front rigid body 105 includes one or more electronic display elements (not shown in FIG. 1), one or more integrated eye tracking systems (not shown in FIG. 1), an Inertial Measurement Unit (IMU) 130, one or more position sensors 135, and the reference point 115. In the embodiment shown by FIG. 1, the position sensors 135 are located within the IMU 130, and neither the IMU 130 nor the position sensors 135 are visible to a user of the HIVID 100. The IMU 130 is an electronic device that generates fast calibration data based on measurement signals received from one or more of the position sensors 135. A position sensor 135 generates one or more measurement signals in response to motion of the HIVID 100. Examples of position sensors 135 include: one or more accelerometers, one or more gyroscopes, one or more magnetometers, another suitable type of sensor that detects motion, a type of sensor used for error correction of the IMU 130, or some combination thereof. The position sensors 135 may be located external to the IMU 130, internal to the IMU 130, or some combination thereof.

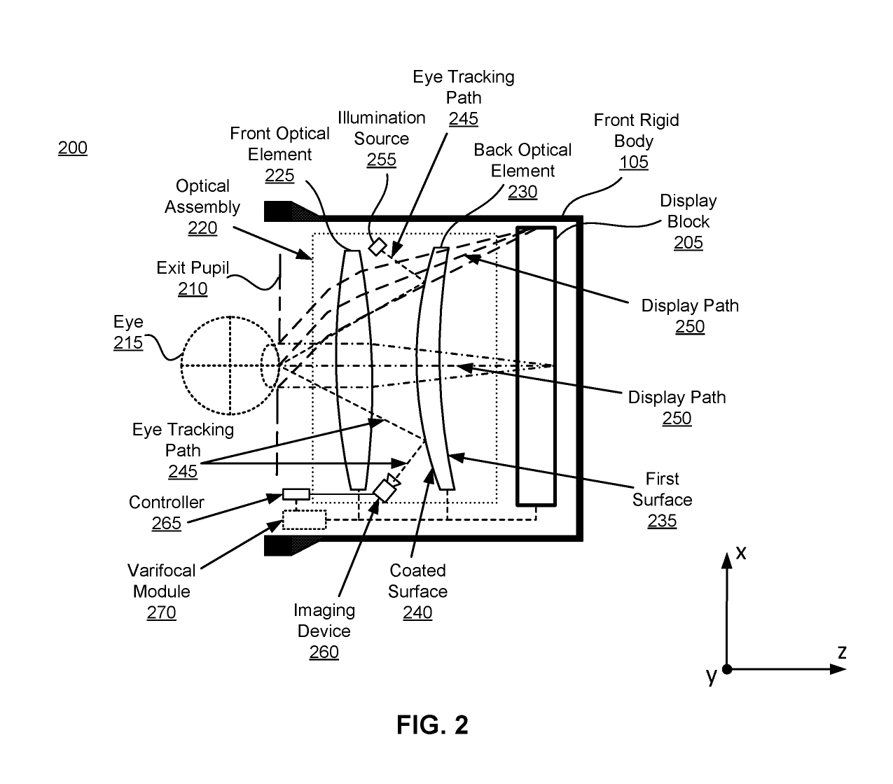

FIG. 2 is a cross section 200 of a front rigid body 105 of the embodiment of the HIVID 100 shown in FIG. 1. As shown in FIG. 2, the front rigid body 105 includes a display block 205 with at least one electronic display that provides focus adjusted image light to an exit pupil 210. The exit pupil 210 is the location of the front rigid body 105 where a user's eye 215 is positioned. For purposes of illustration, FIG. 2 shows a cross section 200 associated with a single eye 215, but another display block, separate from the display block 205, provides altered image light to another eye of the user.

The display block 205 generates image light. In some embodiments, the display block 205 includes an optical element that adjusts the focus of the generated image light. The display block 205 displays images to the user in accordance with data received from a console (not shown in FIG. 2). In various embodiments, the display block 205 may comprise a single electronic display or multiple electronic displays (e.g., a display for each eye of a user). Examples of the electronic display include: a liquid crystal display (LCD), an organic light emitting diode (OLED) display, an inorganic light emitting diode (ILED) display, an active-matrix organic light-emitting diode (AMOLED) display, a transparent organic light emitting diode (TOLED) display, some other display, a projector, or some combination thereof. The display block 205 may also include an aperture, a Fresnel lens, a convex lens, a concave lens, a diffractive element, a waveguide, a filter, a polarizer, a diffuser, a fiber taper, a reflective surface, a polarizing reflective surface, or any other suitable optical element that affects the image light emitted from the electronic display. In some embodiments, one or more of the display block optical elements may have one or more coatings, such as anti-reflective coatings.

An optical assembly 220 magnifies received light from the display block 205, corrects optical aberrations associated with the image light, and the corrected image light is presented to a user of the HMD. At least one optical element of the optical assembly 220 may be an aperture, a Fresnel lens, a refractive lens, a reflective surface, a diffractive element, a waveguide, a filter, a reflective surface, a polarizing reflective surface, or any other suitable optical element that affects the image light emitted from the display block 205. Moreover, as discussed in more detail below, the optical assembly 220 may include combinations of different optical elements. In some embodiments, one or more of the optical elements in the optical assembly 220 may have one or more coatings, such as anti-reflective coatings, dichroic coatings, etc. Magnification of the image light by the optical assembly 220 allows elements of the display block 205 to be physically smaller, weigh less, and consume less power than larger displays. Additionally, magnification may increase a field of view of the displayed media. For example, the field of view of the displayed media is such that the displayed media is presented using almost all (e.g., 110 degrees diagonal), and in some cases all, of the user's field of view. In some embodiments, the optical assembly 220 is designed so its effective focal length is larger than the spacing to the display block 205, which magnifies the image light projected by the display block 205. Additionally, in some embodiments, the amount of magnification may be adjusted by adding or removing optical elements. In some embodiments, the optical assembly 220 is telecentric or approximately telecentric. The optical assembly 220 is considered telecentric or approximately telecentric when the optical assembly 220 features a chief ray angle (CRA) across the user's field of view of less than 10 degrees. A telecentric or approximately telecentic optical assembly 220 provides improved uniformity of illumination across the field of view to the eye 215 with image light output from the display block 205. In addition, a telecentric or approximately telecentric optical assembly 220 is less sensitive to misalignments than non-telecentric optical systems. For example, if the user is not accommodating to the display plane, a telecentric or approximately telecentric optical assembly 220 will not have a noticeable change in magnification. This also relaxes the degree of severity for distortion correction in a focus adjusted display system, such as variable focus entails.

In some embodiments, as discussed in more detail below, the front rigid body 105 of the HMD 100 further includes an eye tracking system, which may be integrated into the optical assembly 220 for determining and tracking an orientation of the user's eye 215 in an eye-box. Based on the determined and tracked orientation of the user's eye 215 (i.e., eye-gaze), the HIVID 100 may adjust presentation of an image displayed on the electronic display of the display block 205, i.e., the HIVID 100 may adjust resolution of the displayed image. A maximum pixel density for displaying an image on the electronic display of the display block 205 can be provided only in a foveal region of the determined eye-gaze, whereas a lower resolution display is employed in other regions, without negatively affecting the user's visual experience.

The optical assembly 220 comprises a front optical element 225 closest to the exit pupil 210 placed in optical series with a back optical element 230 closest to the display block 205. The back optical element 230 is configured to receive image light emitted from an electronic display of the display block 205. The back optical element 230 comprises a first surface 235 adjacent to the display block 205 and a surface 240 opposite to the first surface 235. The surface 240 can be configured to reflect light of a defined range of wavelengths. In some embodiments, the surface 240 is coated with a dichroic coating or a metal coating to reflect light of the defined range of wavelengths for an eye tracking path 245 and transmit light of a visible spectrum for a display path 250 of image light output from the display block 205 towards the user's eye 215. In one or more embodiments, the defined range of wavelengths comprises one or more wavelengths larger than 750 nm, i.e., the surface 240 is coated to reflect IR light and transmit visible light. In an embodiment, the surface 240 of the back optical element 230 is symmetrical and spherical, which facilitates a simpler fabrication and coating process. In an alternative embodiment, only a portion of the surface 240 is coated, e.g., with the metal coating and/or the dichroic coating, to reflect light of the defined range of wavelengths. In this case, only the coated portion of the surface 240 is illuminated and reflects light towards the user's eye 215. By coating only the portion of the surface 240, it is possible to optimize an area of the surface 240 that needs to be coated as well as limit the amount of stress built up in the coating process that depends on a size of the area of the surface 240 being coated.

In one or more embodiments, a Fresnel lens can be positioned on the first surface 235 of the back optical element 230 in the display path 250 associated with the user's eye 215. For example, the Fresnel lens coupled to the first surface 235 of the back optical element 230 can correct aberrations when outputting image light from the electronic display of the display block 205 towards the user's eye 215.

In some embodiments, the front optical element 225 and the back optical element 230 can be made out of different materials. For example, the front optical element 225 may be made out of materials that are harder to scratch. Also, the back optical element 230 may be environmentally sealed in order to prevent dust/dirt/moisture from getting behind the back optical element 230.

In some embodiments, the front optical element 225 can be configured as replaceable. For example, to compensate for a user's optical prescription when performing optical correction of the image light, a user can remove the front optical element 225 and replace it with another optical element of a different optical power than that of the front optical element 225. In one or more embodiments, the front optical element 225 can be selected from a set of optical elements, wherein each optical element from the set has a different optical characteristic. For example, each optical element in the set has a different spherical optical power. In an illustrative embodiment, the set of optical elements comprises spherical lenses with spherical optical powers of −6, −3, 0, and +3 diopters, and other lenses with the same spherical optical powers having additional diopters for astigmatism. When implemented as reconfigurable, the front optical element 225 can be also configured to provide distortion update utilized by the eye tracking system for determining eye tracking information, as an optical power of the front optical element 225 affects the eye tracking path 245. In an embodiment, information about the distortion update of the front optical element 225 can be provided as an input from the user, e.g., when the front optical element 225 is swapped with another optical element. In another embodiment, information about the distortion update can be generated based on visual identification of the front optical element 225 through a camera of the eye-tracking system. In this case, for example, a special illumination source may be utilized to strike a diffractive or otherwise contrasting pattern on an outside surface of the front optical element 225. In yet another embodiment, information about the distortion update can be generated through a radio frequency identification (RFID) tag imbedded on an edge of the front optical element 225. Alternatively, any other commercially viable method for identifying properties of the front optical element 225 can be used, while maintaining a database of viable optical elements and their distortion/focal length parameters.

In some embodiments, the eye tracking system is integrated within the optical assembly 220 in an air gap between the front optical element 225 and the back optical element 230. As shown in FIG. 2, the eye-tracking system includes an illumination source 255 and an imaging device 260 that are positioned outside a transmitted optical display path 250 of the user's eye 215, i.e., the illumination source 255 and the imaging device 260 are hidden from the user's sight. The illumination source 255 is positioned between the front optical element 225 and the back optical element 230 such that to illuminate the coated surface 240 of the back optical element 230 with light having one or more wavelengths within the defined range of wavelengths. The light (e.g., IR light) emitted from the illumination source 255 is reflected from the coated surface 240 towards the user's eye 215, i.e., the light emitted from the illumination source 255 is propagated along the eye tracking path 245 to a surface of the user's eye 215.

In one embodiment, the illumination source 255 comprises a plurality of emitters that emit IR light. The plurality of emitters of the illumination source 255 may be implemented on a single substrate. In an alternative embodiment, the illumination source 255 may comprise a single emitter of IR light. In yet another embodiment, the illumination source 255 is configured to emit a structured light to illuminate the coated surface 240 of the back optical element 230, wherein the structured light features one or more wavelengths within the defined range of wavelengths to be reflected from the coated surface 240 towards an eye-box of the user's eye 215. In some embodiments, the light emitted from the illumination source 255 and reflected from the coated surface 240 comprises light having one or more wavelengths larger than 750 nm, which is not visible to the user's eye 215. In one embodiment, a length of the eye-box of the user's eye 215 covered by positioning of the illumination source and the imaging device 260 between the front optical element 225 and the back optical element 230 can be between approximately 5 mm and 20 mm.

In some embodiments, the imaging device 260 is oriented between the front optical element 225 and the back optical element 230 of the optical assembly 220 such that the imaging device 260 captures an image of the eye 215 illuminated with light that propagates along the eye tracking path 245. Thus, the imaging device 260 captures light reflected from a surface of the eye 215 that was emitted from the illumination source 255 and reflected from the coated surface 240. In one or more embodiments, the imaging device 260 comprises a camera configured to capture images in the IR. As illustrated in FIG. 2, the light that propagates along the eye-tracking path 245 that was reflected from a surface of the user's eye 215 may be further reflected from the coated surface 240 before being captured by the imaging device 260. In this way, a wide field of view of the user's eye 215 can be captured, e.g., the field of view of approximately 100 degrees can be covered by appropriate positioning of the illumination source 255 and the imaging device 260.

As further shown in FIG. 2, a controller 265 is coupled to the imaging device 260. In some embodiments, the controller 265 is configured to determine eye tracking information associated with the user's eye 215 based on the light reflected from a surface of the user's eye 215 and captured by the imaging device 260, i.e., based on the light propagating along the eye tracking path 245 captured by the imaging device 260. In one or more embodiments, the eye tracking information determined by the controller 265 may comprise information about an orientation of the eye 215, i.e., an angle of eye-gaze and eye-gaze location.

In some embodiments, the HIVID 100 in FIG. 1 can adjust presentation of one or more images (e.g., two dimensional (2D) or three dimensional (3D) images) displayed on the electronic display of the display block 205, based on the determined eye tracking information. In one embodiment, the controller 265 is configured to adjust resolution of the displayed images, based on the determined eye tracking information. For example, the controller 265 can instruct a console (not shown in FIG. 2) to perform foveated rendering of the displayed images, based on the determined orientation of the user's eye 215. In this case, the console may provide a maximum pixel density for the display block 205 only in a foveal region of the user's eye-gaze, while a lower pixel resolution for the display block 205 can be used in other regions of the electronic display of the display block 205.

In some embodiments, a varifocal module 270 may be coupled to the controller 265 and configured to adjust presentation of images displayed on the electronic display of the display block 205 by adjusting focus of the displayed images, based on the determined eye tracking information obtained from the controller 265. In one or more embodiments, at least one of the display block 205, the front optical element 225 and the back optical element 230 can be configured to be movable to dynamically vary focus of the images displayed on the electronic display of the display block 205. For example, the display block 205, the front optical element 225, and the back optical element 230 can be configured to be movable along z axis of a coordinate system shown in FIG. 2, i.e., along an optical axis of the optical assembly 220. In this case, the varifocal module 270 can be mechanically coupled with at least one of the display block 205, the front optical element 225 and the back optical element 230. In an embodiment, the varifocal module 270 is coupled to a motor (not shown in FIG. 2) that can move at least one of the display block 205, the back optical element 230 and the front optical element 225, e.g., along the z axis. Then, the varifocal module 270 can adjust focus of the displayed images by instructing the motor to adjust position of at least one of the display block 205, the front optical element 225 and the back optical element 230, based on the determined eye tracking information obtained from the controller 265. Thus, a distance between the front optical element 225 and the back optical element 230 along the optical axis of the optical assembly 220 can be variable and controlled by the varifocal module 270. Similarly, a distance between the back optical element 230 and the display block 205 along the optical axis can be also variable and controlled by the varifocal module 270. By adjusting position of the at least one of the display block 205, the front optical element 225 and the back optical element 230 along the optical axis, the varifocal module 270 varies focus of image light output from the display block 205 towards the user's eye 215 to ensure that a displayed image is in focus at the determined location of user's eye-gaze. Furthermore, by adjusting focus of the image light, the varifocal module 270 can also mitigate VAC associated with the image light. In this case, the varifocal module 270 is configured to adjust a position of the display block 205 to present proper vergence/accommodation cues when, for example, virtual/augmented scenes are closer in presentation. Additional details regarding HMDs with varifocal capability are discussed in U.S. application Ser. No. 14/963,126, filed Dec. 8, 2015, and is herein incorporated by reference in its entirety.

In some embodiments, the varifocal module 270 may be also configured to adjust resolution of the images displayed on the electronic display of the display block 205 by performing the foveated rendering of the displayed images, based on the determined eye tracking information received from the controller 265. In this case, the varifocal module 270 is electrically coupled to the display block 205 and provides image signals associated with the foveated rendering to the display block 205. The varifocal module 270 may provide a maximum pixel density for the display block 205 only in a foveal region of the user's eye-gaze, while a lower pixel resolution for the display block 205 can be used in other regions of the electronic display of the display block 205. In alternative configurations, different and/or additional components may be included in the front rigid body 105, which may be configured to adjust presentation of one or more images displayed on the electronic display of the display block 205, based on the determined eye tracking information.

In some embodiments, as discussed, the front optical element 225 can be configured as replaceable, i.e., the front optical element 225 can be replaced with another optical element of a different optical power to compensate for a user's optical prescription. The varifocal module 270 can be configured to compensate for a difference between the user's optical prescription and an optical characteristic of the front optical element 225 to provide optical correction to image light emitted from the electronic display of the display block 205 through the back optical element 230 and the front optical element 225 to the user's eye 215. For example, a user can select the front optical element 225 having an optical characteristic that is closest to a user's optical prescription, including a spherical optical power and astigmatism correction (e.g., through manual rotation of the front optical element 225). Then, the varifocal module 270 can compensate for the remaining error between the optical characteristic of the front optical element 225 and the user's optical prescription.

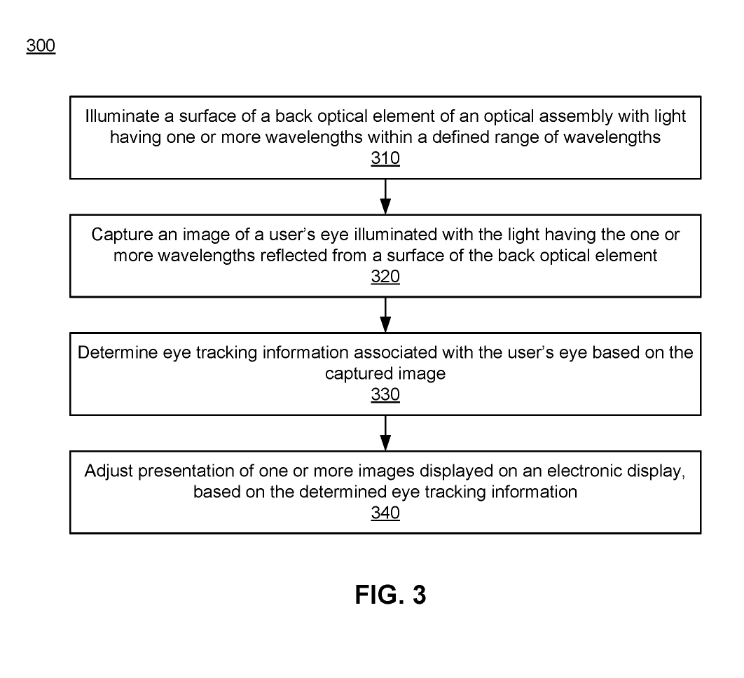

FIG. 3 is a flow chart illustrating a process 300 of determining eye tracking information and adjusting presentation of displayed images based on the determined eye tracking information, which may be implemented at the HMD 100 shown in FIG. 1, in accordance with an embodiment. The process 300 of FIG. 3 may be performed by the components of a HMD (e.g., the HIVID 100). Other entities may perform some or all of the steps of the process in other embodiments. Likewise, embodiments may include different and/or additional steps, or perform the steps in different orders.

The HIVID illuminates (e.g., via an illumination source) 310 a surface of a back optical element of an optical assembly with light having one or more wavelengths within a defined range of wavelengths. In some embodiments, the light can be emitted from an illumination source positioned within the optical assembly between a front optical element closest to a user and the back optical element closest to an electronic display. The illumination source is positioned outside a line of sight of the user. The surface of the back optical element is coated to reflect light of the defined range of wavelengths.

The HIVID captures 320 (e.g., via an imaging device) an image of a user's eye illuminated with the light emitted from the illumination source having the one or more wavelengths reflected from the surface of the back optical element. In some embodiments, the imaging device is positioned within the optical assembly between the front optical element and the back optical element, outside the user's line of sight.

The HIVID determines 330 (e.g., via a controller) eye tracking information associated with the user's eye based on the captured image. The determined eye tracking information may comprise information about an orientation of the user's eye in an eye-box, i.e., information about an angle of an eye-gaze. In an embodiment, the user's eye may be illuminated with a structured light. Then, the controller can use locations of reflected structured light in the captured image to determine eye position and eye-gaze. In another embodiment, the controller may determine eye position and eye-gaze based on magnitudes of image light captured by the imaging device over a plurality of time instants.

The HIVID adjusts 340 (e.g., via a varifocal module) presentation of one or more images displayed on the electronic display, based on the determined eye tracking information. In one embodiment, the HIVID adjusts 340 presentation of the one or more images displayed on the electronic display by adjusting a focal distance of the optical assembly based on the determined eye tracking information. The focal distance of the optical assembly can be adjusted by moving the electronic display and/or optical elements along an optical axis, which also mitigates VAC associated with image light. In another embodiment, the HIVID adjusts 340 presentation of the one or more images displayed on the electronic display by performing foveated rendering of the one or more images based on the determined eye tracking information. In an embodiment, the HIVID (e.g., via the varifocal module) can compensate for a difference between a user's optical prescription and an optical characteristic of the front optical element to provide optical correction to image light emitted from the electronic display through the back optical element and the front optical element to the user's eye. In this case, the front optical element is configured as replaceable and it is selected to have an optical characteristic that is closest to the user's optical prescription, including a spherical optical power and astigmatism correction.

### System Environment

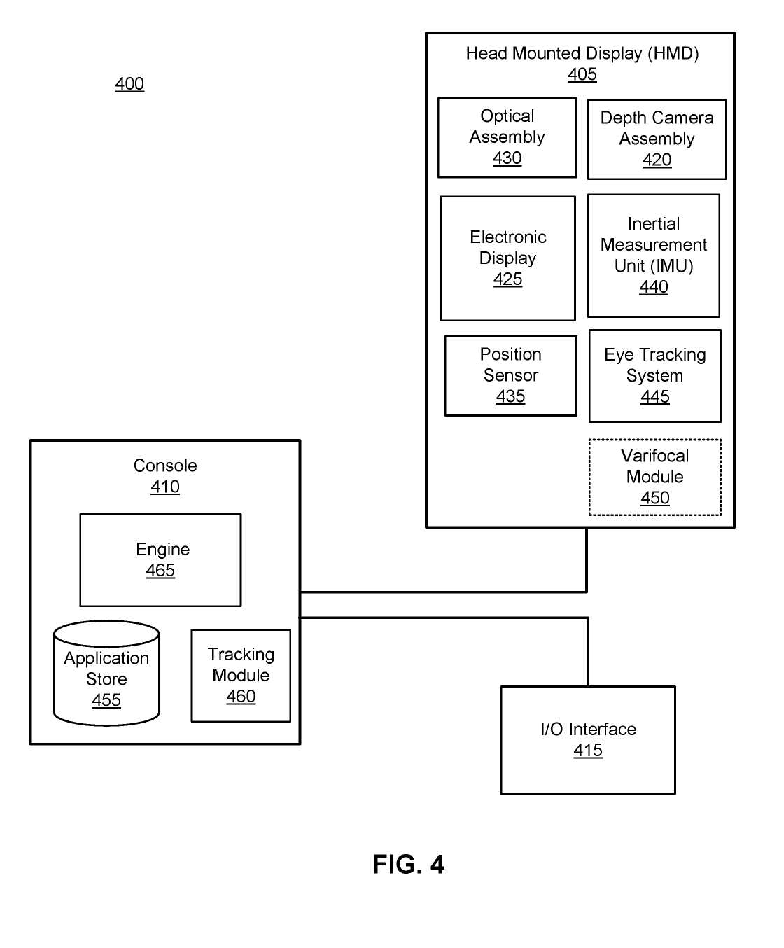

FIG. 4 is a block diagram of one embodiment of a HIVID system 400 in which a console 410 operates. The HIVID system 400 may operate in a VR system environment, an AR system environment, a MR system environment, or some combination thereof. The HIVID system 400 shown by FIG. 4 comprises a HIVID 405 and an input/output (I/O) interface 415 that is coupled to the console 410. While FIG. 4 shows an example HIVID system 400 including one HIVID 405 and on I/O interface 415, in other embodiments any number of these components may be included in the HIVID system 400. For example, there may be multiple HMDs 405 each having an associated I/O interface 415, with each HIVID 405 and I/O interface 415 communicating with the console 410. In alternative configurations, different and/or additional components may be included in the HMD system 400. Additionally, functionality described in conjunction with one or more of the components shown in FIG. 4 may be distributed among the components in a different manner than described in conjunction with FIG. 4 in some embodiments. For example, some or all of the functionality of the console 410 is provided by the HMD 405.

The HMD 405 is a head-mounted display that presents content to a user comprising virtual and/or augmented views of a physical, real-world environment with computer-generated elements (e.g., 2D or 3D images, 2D or 3D video, sound, etc.). In some embodiments, the presented content includes audio that is presented via an external device (e.g., speakers and/or headphones) that receives audio information from the HIVID 405, the console 410, or both, and presents audio data based on the audio information. The HIVID 405 may comprise one or more rigid bodies, which may be rigidly or non-rigidly coupled together. A rigid coupling between rigid bodies causes the coupled rigid bodies to act as a single rigid entity. In contrast, a non-rigid coupling between rigid bodies allows the rigid bodies to move relative to each other. An embodiment of the HIVID 405 is the HIVID 100 described above in conjunction with FIG. 1.

The HIVID 405 includes a DCA 420, an electronic display 425, an optical assembly 430, one or more position sensors 435, an IMU 440, an eye tracking system 445, and an optional varifocal module 450. In some embodiments, the eye-tracking system 445 may be integrated within the optical assembly 430, as described above in conjunction with FIG. 2. Some embodiments of the HIVID 405 have different components than those described in conjunction with FIG. 4. Additionally, the functionality provided by various components described in conjunction with FIG. 4 may be differently distributed among the components of the HIVID 405 in other embodiments.

The DCA 420 captures data describing depth information of an area surrounding the HMD 405. The data describing depth information may be associated with one or a combination of the following techniques used to determine depth information: structured light, time of flight, or some combination thereof. The DCA 420 can compute the depth information using the data, or the DCA 420 can send this information to another device such as the console 410 that can determine the depth information using data from the DCA 420.

The DCA 420 includes an illumination source, an imaging device, and a controller. The illumination source emits light onto an area surrounding the HIVID. The illumination source includes a plurality of emitters on a single substrate. The imaging device captures ambient light and light from one or more emitters of the plurality of emitters that is reflected from objects in the area. The controller coordinates how the illumination source emits light and how the imaging device captures light. In some embodiments, the controller may also determine depth information associated with the local area using the captured images.

The illumination source includes a plurality of emitters that each emits light having certain characteristics (e.g., wavelength, polarization, coherence, temporal behavior, etc.). The characteristics may be the same or different between emitters, and the emitters can be operated simultaneously or individually. In one embodiment, the plurality of emitters could be, e.g., laser diodes (e.g., edge emitters), inorganic or organic LEDs, a vertical-cavity surface-emitting laser (VCSEL), or some other source. In some embodiments, a single emitter or a plurality of emitters in the illumination source can emit light having a structured light pattern.

The electronic display 425 displays 2D or 3D images to the user in accordance with data received from the console 410. In various embodiments, the electronic display 425 comprises a single electronic display or multiple electronic displays (e.g., a display for each eye of a user). Examples of the electronic display 425 include: a liquid crystal display (LCD), an organic light emitting diode (OLED) display, an inorganic light emitting diode (ILED) display, an active-matrix organic light-emitting diode (AMOLED) display, a transparent organic light emitting diode (TOLED) display, some other display, or some combination thereof.

The optical assembly 430 magnifies image light received from the electronic display 425, corrects optical errors associated with the image light, and presents the corrected image light to a user of the HMD 405. In various embodiments, the optical assembly 430 is an embodiment of the optical assembly 220 described above in conjunction with FIG. 2. The optical assembly 430 includes a plurality of optical elements. Example optical elements included in the optical assembly 430 include: an aperture, a Fresnel lens, a convex lens, a concave lens, a filter, a reflecting surface, or any other suitable optical element that affects image light. Moreover, the optical assembly 430 may include combinations of different optical elements. In some embodiments, one or more of the optical elements in the optical assembly 430 may have one or more coatings, such as partially reflective or anti-reflective coatings.

Magnification and focusing of the image light by the optical assembly 430 allows the electronic display 425 to be physically smaller, weigh less and consume less power than larger displays. Additionally, magnification may increase the field of view of the content presented by the electronic display 425. For example, the field of view of the displayed content is such that the displayed content is presented using almost all (e.g., approximately 110 degrees diagonal), and in some cases all, of the user's field of view. Additionally in some embodiments, the amount of magnification may be adjusted by adding or removing optical elements.

In some embodiments, the optical assembly 430 may be designed to correct one or more types of optical error. Examples of optical error include barrel or pincushion distortions, longitudinal chromatic aberrations, or transverse chromatic aberrations. Other types of optical errors may further include spherical aberrations, chromatic aberrations or errors due to the lens field curvature, astigmatisms, or any other type of optical error. In some embodiments, content provided to the electronic display 425 for display is pre-distorted, and the optical assembly 430 corrects the distortion when it receives image light from the electronic display 425 generated based on the content.

The IMU 440 is an electronic device that generates data indicating a position of the HIVID 405 based on measurement signals received from one or more of the position sensors 435 and from depth information received from the DCA 420. A position sensor 435 generates one or more measurement signals in response to motion of the HIVID 405. Examples of position sensors 435 include: one or more accelerometers, one or more gyroscopes, one or more magnetometers, another suitable type of sensor that detects motion, a type of sensor used for error correction of the IMU 440, or some combination thereof. The position sensors 435 may be located external to the IMU 440, internal to the IMU 440, or some combination thereof.

Based on the one or more measurement signals from one or more position sensors 435, the IMU 440 generates data indicating an estimated current position of the HIVID 405 relative to an initial position of the HIVID 405. For example, the position sensors 435 include multiple accelerometers to measure translational motion (forward/back, up/down, left/right) and multiple gyroscopes to measure rotational motion (e.g., pitch, yaw, roll). In some embodiments, the IMU 440 rapidly samples the measurement signals and calculates the estimated current position of the HIVID 405 from the sampled data. For example, the IMU 440 integrates the measurement signals received from the accelerometers over time to estimate a velocity vector and integrates the velocity vector over time to determine an estimated current position of a reference point on the HIVID 405. Alternatively, the IMU 440 provides the sampled measurement signals to the console 410, which interprets the data to reduce error. The reference point is a point that may be used to describe the position of the HMD 405. The reference point may generally be defined as a point in space or a position related to the HMD's 405 orientation and position.

The IMU 440 receives one or more parameters from the console 410. The one or more parameters are used to maintain tracking of the HIVID 405. Based on a received parameter, the IMU 440 may adjust one or more IMU parameters (e.g., sample rate). In some embodiments, certain parameters cause the IMU 440 to update an initial position of the reference point so it corresponds to a next position of the reference point. Updating the initial position of the reference point as the next calibrated position of the reference point helps reduce accumulated error associated with the current position estimated the IMU 440. The accumulated error, also referred to as drift error, causes the estimated position of the reference point to “drift” away from the actual position of the reference point over time. In some embodiments of the HIVID 405, the IMU 440 may be a dedicated hardware component. In other embodiments, the IMU 440 may be a software component implemented in one or more processors.

The eye tracking system 445 determines eye tracking information associated with an eye of a user wearing the HIVID 405. The eye tracking information determined by the eye tracking system 445 may comprise information about an orientation of the user's eye, i.e., information about an angle of an eye-gaze. The eye tracking system 445 is an embodiment of the eye-tracking system described above in conjunction with FIG. 2 that includes the illumination source 255, the imaging device 260 and the controller 265. In some embodiments, the eye tracking system 445 is integrated into the optical assembly 430. The eye-tracking system 445 may comprise an illumination source, an imaging device and a controller integrated within an air gap between a pair of optical elements of the optical assembly 430.

In some embodiments, the varifocal module 450 is integrated into the HMD 405. An embodiment of the varifocal module 450 is the varifocal module 270 described above in conjunction with FIG. 2. The varifocal module 450 can be coupled to the eye tracking system 445 to obtain eye tracking information determined by the eye tracking system 445. The varifocal module 450 is configured to adjust focus of one or more images displayed on the electronic display 425, based on the determined eye tracking information obtained from the eye tracking system 445. The varifocal module 450 can be interfaced (e.g., either mechanically or electrically) with at least one of the electronic display 425, the front optical element of the optical assembly 430, and the back optical element of the optical assembly 430. Then, the varifocal module 450 adjusts focus of the one or more images displayed on the electronic display 425 by adjusting position of at least one of the electronic display 425, the front optical element of the optical assembly and the back optical element of the optical assembly 430, based on the determined eye tracking information obtained from the eye tracking system 445. By adjusting position of the at least one of the electronic display 425 and at least one optical element of the optical assembly 430, the varifocal module 450 varies focus of image light output from the electronic display 425 towards the user's eye.

The varifocal module 450 may be also configured to adjust resolution of the images displayed on the electronic display 425 by performing foveated rendering of the displayed images, based at least in part on the determined eye tracking information obtained from the eye tracking system 445. In this case, the varifocal module 450 provides appropriate image signals to the electronic display 425. The varifocal module 450 provides image signals with a maximum pixel density for the electronic display 425 only in a foveal region of the user's eye-gaze, while providing image signals with lower pixel densities in other regions of the electronic display 425.

The I/O interface 415 is a device that allows a user to send action requests and receive responses from the console 410. An action request is a request to perform a particular action. For example, an action request may be an instruction to start or end capture of image or video data or an instruction to perform a particular action within an application. The I/O interface 415 may include one or more input devices. Example input devices include: a keyboard, a mouse, a game controller, or any other suitable device for receiving action requests and communicating the action requests to the console 410. An action request received by the I/O interface 415 is communicated to the console 410, which performs an action corresponding to the action request. In some embodiments, the I/O interface 415 includes an IMU 440 that captures calibration data indicating an estimated position of the I/O interface 415 relative to an initial position of the I/O interface 415. In some embodiments, the I/O interface 415 may provide haptic feedback to the user in accordance with instructions received from the console 410. For example, haptic feedback is provided when an action request is received, or the console 410 communicates instructions to the I/O interface 415 causing the I/O interface 415 to generate haptic feedback when the console 410 performs an action.

The console 410 provides content to the HIVID 405 for processing in accordance with information received from one or more of: the DCA 420, the HIVID 405, and the I/O interface 415. In the example shown in FIG. 4, the console 410 includes an application store 455, a tracking module 460, and an engine 465. Some embodiments of the console 410 have different modules or components than those described in conjunction with FIG. 4. Similarly, the functions further described below may be distributed among components of the console 410 in a different manner than described in conjunction with FIG. 4.

The application store 455 stores one or more applications for execution by the console 410. An application is a group of instructions, that when executed by a processor, generates content for presentation to the user. Content generated by an application may be in response to inputs received from the user via movement of the HIVID 405 or the I/O interface 415. Examples of applications include: gaming applications, conferencing applications, video playback applications, or other suitable applications.

The tracking module 460 calibrates the HMD system 400 using one or more calibration parameters and may adjust one or more calibration parameters to reduce error in determination of the position of the HIVID 405 or of the I/O interface 415. For example, the tracking module 460 communicates a calibration parameter to the DCA 420 to adjust the focus of the DCA 420 to more accurately determine positions of structured light elements captured by the DCA 420. Calibration performed by the tracking module 460 also accounts for information received from the IMU 440 in the HIVID 405 and/or an IMU 440 included in the I/O interface 415. Additionally, if tracking of the HIVID 405 is lost (e.g., the DCA 420 loses line of sight of at least a threshold number of structured light elements), the tracking module 460 may re-calibrate some or all of the HIVID system 400.

The tracking module 460 tracks movements of the HIVID 405 or of the I/O interface 415 using information from the DCA 420, the one or more position sensors 435, the IMU 440 or some combination thereof. For example, the tracking module 460 determines a position of a reference point of the HIVID 405 in a mapping of a local area based on information from the HIVID 405. The tracking module 460 may also determine positions of the reference point of the HIVID 405 or a reference point of the I/O interface 415 using data indicating a position of the HIVID 405 from the IMU 440 or using data indicating a position of the I/O interface 415 from an IMU 440 included in the I/O interface 415, respectively. Additionally, in some embodiments, the tracking module 460 may use portions of data indicating a position or the HIVID 405 from the IMU 440 as well as representations of the local area from the DCA 420 to predict a future location of the HMD 405. The tracking module 460 provides the estimated or predicted future position of the HMD 405 or the I/O interface 415 to the engine 465.

The engine 465 generates a 3D mapping of the area surrounding the HIVID 405 (i.e., the “local area”) based on information received from the HIVID 405. In some embodiments, the engine 465 determines depth information for the 3D mapping of the local area based on information received from the DCA 420 that is relevant for techniques used in computing depth. The engine 465 may calculate depth information using one or more techniques in computing depth (e.g., structured light, time of flight, or some combination thereof). In various embodiments, the engine 465 uses different types of information determined by the DCA 420 or a combination of types of information determined by the DCA 420.

The engine 465 also executes applications within the system environment 400 and receives position information, acceleration information, velocity information, predicted future positions, or some combination thereof, of the HIVID 405 from the tracking module 460. Based on the received information, the engine 465 determines content to provide to the HIVID 405 for presentation to the user. For example, if the received information indicates that the user has looked to the left, the engine 465 generates content for the HIVID 405 that mirrors the user's movement in a virtual environment or in an environment augmenting the local area with additional content. Additionally, the engine 465 performs an action within an application executing on the console 410 in response to an action request received from the I/O interface 415 and provides feedback to the user that the action was performed. The provided feedback may be visual or audible feedback via the HIVID 405 or haptic feedback via the I/O interface 415.

In some embodiments, based on the eye tracking information (e.g., orientation of the user's eye) received from the eye tracking system 445, the engine 465 determines resolution of the content provided to the HMD 405 for presentation to the user on the electronic display 425. The engine 465 provides the content to the HIVID 405 having a maximum pixel density (maximum resolution) on the electronic display 425 in a foveal region of the user's gaze, whereas the engine 465 provides a lower pixel resolution in other regions of the electronic display 425, thus achieving less power consumption at the HIVID 405 and saving computing cycles of the console 410 without compromising a visual experience of the user.

### Additional Configuration Information

The foregoing description of the embodiments of the disclosure has been presented for the purpose of illustration; it is not intended to be exhaustive or to limit the disclosure to the precise forms disclosed. Persons skilled in the relevant art can appreciate that many modifications and variations are possible in light of the above disclosure.

Some portions of this description describe the embodiments of the disclosure in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the disclosure may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the disclosure may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the disclosure be limited not by this detailed description, but rather by any claims that issue on an application based hereon. Accordingly, the disclosure of the embodiments is intended to be illustrative, but not limiting, of the scope of the disclosure, which is set forth in the following claims.

What is claimed is:

1. A head-mounted display (HMD) comprising:
an electronic display;
an optical assembly comprising a front optical element in series with a back optical element adjacent to the electronic display, the back optical element comprises a first surface adjacent to the electronic display and a second surface opposite to the first surface configured to reflect light of a defined range of wavelengths;
an illumination source positioned between the front optical element and the back optical element, the illumination source configured to illuminate the second surface of the back optical element with light having one or more wavelengths within the defined range of wavelengths;
an imaging device positioned between the front optical element and the back optical element, the imaging device configured to capture an image of a user's eye illuminated with light emitted from the illumination source having the one or more wavelengths reflected from the second surface of the back optical element; and
a controller coupled to the imaging device, the controller configured to determine an orientation of the user's eye based on the captured image, and
wherein the system is configured to adjust presentation of one or more images displayed on the electronic display, based on the determined orientation of the user's eye.

2. The HMD of claim 1, further comprising:
a varifocal module configured to adjust presentation of the one or more images displayed on the electronic display by adjusting focus of the one or more images based on the determined orientation of the user's eye.

3. The HMD of claim 1, further comprising:
a varifocal module configured to adjust presentation of the one or more images displayed on the electronic display by performing foveated rendering of the one or more images based on the determined orientation of the user's eye.

4. The HMD of claim 1, further comprising:
a varifocal module configured to adjust presentation of the one or more images displayed on the electronic display by adjusting position of at least one of the electronic display, the front optical element and the back optical element, based on the determined orientation of the user's eye.

5. The HMD of claim 1, wherein at least one of the electronic display, the front optical element and the back optical element is configured to be movable to dynamically vary focus of the one or more images displayed on the electronic display.

6. The HIVID of claim 1, wherein the illumination source emits a structured light, spatially or temporally, the structured light being folded into an optical path by reflecting off of the second surface of the back optical element, and the structured light having a wavelength within the defined range of wavelengths.

7. The HMD of claim 1, wherein the illumination source comprises a plurality of emitters.

8. The HMD of claim 1, wherein:
the light having the one or more wavelengths reflected from the second surface of the back optical element comprises infrared (IR) light; and
the imaging device comprises a camera configured to capture images in the IR.

9. The HIVID of claim 1, wherein the defined range of wavelengths comprises one or more wavelengths larger than 750 nm.

10. The HIVID of claim 1, wherein the illumination source and the imaging device are positioned outside of a transmitted optical path of the user's eye.

11. The HIVID of claim 1, wherein the second surface is coated to reflect light of the defined range of wavelengths and transmit visible light.

12. The HIVID of claim 1, wherein a shape of the second surface is spherical, aspherical, or free-form.

13. The HIVID of claim 1, wherein:
a portion of the second surface is coated;
the illumination source is configured to illuminate only the coated portion of the second surface; and
the coated portion of the second surface reflects light of the defined range of wavelengths towards the user's eye and the imaging device.

14. The HMD of claim 1, wherein a Fresnel lens is positioned on the first surface of the back optical element in an optical path of the user's eye and configured to correct aberration when outputting light of the one or more images to the user's eye.

15. The HMD of claim 1, wherein the optical assembly is telecentric.

16. The HIVID of claim 1, wherein the imaging device is oriented to capture the image of the user's eye illuminated with the light reflected from the user's eye and then from the second surface of the back optical element.

17. A head-mounted display (HMD) comprising:
an electronic display configured to emit image light;
an optical assembly comprising a front optical element in series with a back optical element adjacent to the electronic display, the back optical element comprises a first surface adjacent to the electronic display and a second surface opposite to the first surface configured to reflect light of a defined range of wavelengths;
an eye tracking system that determines eye tracking information for a first eye of a user of the HIVID, the eye tracking system comprising:
an illumination source positioned between the front optical element and the back optical element, the illumination source configured to illuminate the second surface of the back optical element with light having one or more wavelengths within the defined range of wavelengths,
an imaging device positioned between the front optical element and the back optical element, the imaging device configured to capture an image of a user's eye illuminated with light emitted from the illumination source having the one or more wavelengths reflected from the second surface of the back optical element; and
a controller configured to determine eye tracking information associated with the user's eye based on the captured image, and
wherein the HIVID adjusts presentation of one or more images displayed on the electronic display, based on the determined eye tracking information.

18. The HIVID of claim 17, further comprising:
a varifocal module configured to adjust presentation of the one or more images displayed on the electronic display by adjusting focus of the one or more images based on the determined eye tracking information.

19. The HIVID of claim 17, further comprising:
a varifocal module configured to adjust presentation of the one or more images displayed on the electronic display by performing foveated rendering of the one or more images based on the determined eye tracking information.

20. The HMD of claim 17, wherein the front optical element is replaceable and selected from a set of optical elements to correct for an optical prescription of the user, each optical element from the set having a different optical characteristic.

21. The HMD of claim 17, further comprising:
a varifocal module configured to compensate for a difference between an optical prescription of the user and an optical characteristic of the front optical element to provide optical correction to the image light.

22. The HMD of claim 17, wherein:
the light having the one or more wavelengths reflected from the second surface of the back optical element comprises infrared (IR) light; and
the imaging device comprises a camera configured to capture images in the IR.
